(19) United States
(12) Patent Application Publication
(10) Pub. No.: US 2007/0034034 A1
(43) Pub. Date: Feb. 15, 2007

(54) Transmission Element for a Zero Backlash Transmission, Especially for Precision Mechanics

(75) Inventor: Reiner Bessey, Schönaich (DE)

Correspondence Address: GUDRUN E. HUCKETT DRAUDT, LONSSTR. 53, WUPPERTAL, 42289, DE

(73) Assignee: DR. FRITZ FAULHABER GMBH & CO. KG, Schonaich (DE)

(21) Appl. No.: 11/456,592

(22) Filed: Jul. 11, 2006

(30) Foreign Application Priority Data
Jul. 26, 2005 (DE) 10 2005 036 127.7

(51) Int. Cl. F16H 55/18

(52) U.S. Cl. 74/409

(57) ABSTRACT

A transmission element for a zero backlash transmission with at least two transmission paths that are tensioned relative to one another has a first transmission part and a second transmission part that are elastically tensionable relative to one another. At least one torsion spring element for increasing the elasticity is provided. The torsion spring element transmits torque between the first and second transmission parts and the first and second transmission parts are rotatable relative to one another.

### BACKGROUND OF THE INVENTION

The invention relates to a transmission element for a transmission that is free of backlash, especially for precision mechanics, wherein the transmission has at least two transmission paths that are tensioned relative to one another.

In precision mechanics, spur gear units are known for power transmission and for position control; in the spur gear units the backlash within the transmission is minimized by different technical measures. One possibility resides in that two parallel self-contained transmission paths are provided that are tensioned relative to one another. Depending on the rotational direction, the movements and torque are then transmitted through the first or the second transmission path. The tensioning is possible because of the elasticity of the transmission paths. Constructive tolerances and the pitch of the teeth however do not allow for a process-safe tensioning of the transmissions.

In a known zero backlash transmission (German patent application 100 36 937 A1) a rigid stepped planetary gear and a rotationally elastic and pretensioned stepped planetary gear are provided. Such a transmission configuration is constructively complex and leads to relatively large size transmission units.

In another zero backlash transmission (German patent 25 38 460 C3) a tensioning device is provided with which a gearwheel is connected to the output shaft of a step motor. The tensioning device has a cam disk and a follower disk in which at angular spacings slotted holes are provided that are engaged by axially extending bolts of the cam disk. Within the slotted holes pressure springs act on these bolts so that bracing of the gear unit is achieved. This transmission is also constructively complex and is comprised of a plurality of components.

### SUMMARY OF THE INVENTION

It is an object of the invention to configure a transmission element of the aforementioned kind in such a way that a simple construction is combined with a compact configuration.

This object is solved for the transmission element of the aforementioned kind in accordance with the invention the elasticity of one of the two transmission paths of the transmission is increased so that a process-safe tensioning of the two transmission paths is ensured.

Advantageously, for increasing this elasticity at least one torsion spring element is provided with which two transmission parts are tensioned relative to one another. The torsion spring element can be arranged in a space-saving way within the transmission element and can still ensure a reliable tensioning of the two transmission paths relative to one another.

Further features of the invention result from the dependent claims, the description, and the drawing.

### BRIEF DESCRIPTION OF THE DRAWINGS

The invention will be explained in more detail in the following with the aid of one embodiment illustrated in the drawing. It is shown in:

FIG. 1 an axial section of a transmission element according to the invention;

FIG. 2A a torsion spring element of the transmission element of the present invention in a top view;

FIG. 2B a torsion spring element of the transmission element of the present invention in a side view;

FIG. 3 an end view and a schematic illustration a part of a transmission into which the transmission element according to the invention has been installed.

### DESCRIPTION OF PREFERRED EMBODIMENT

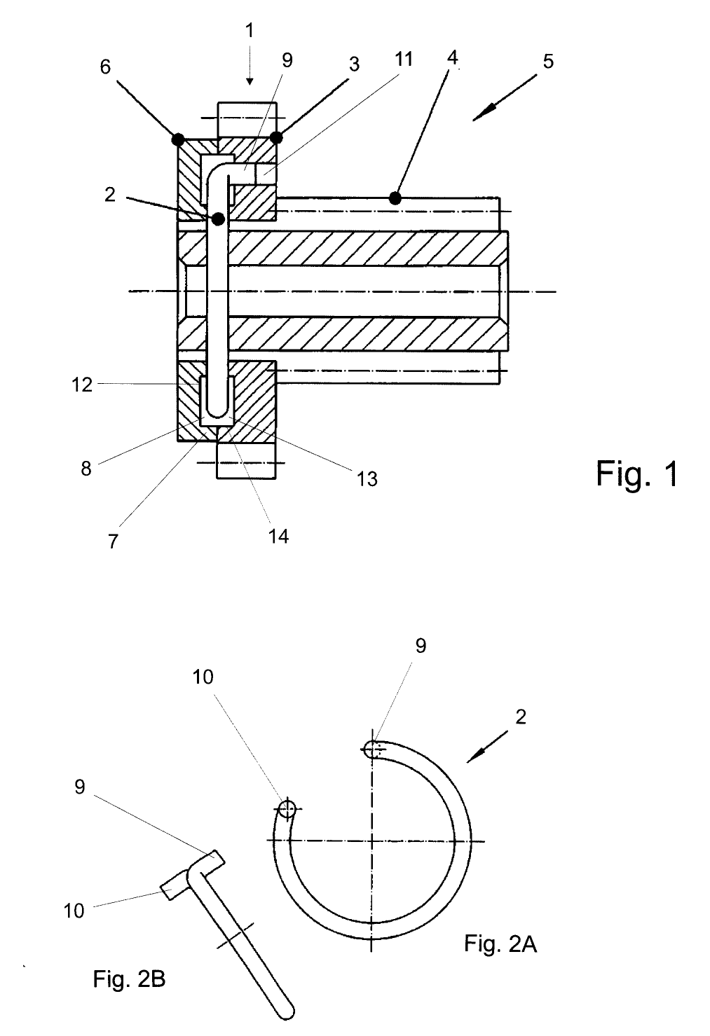

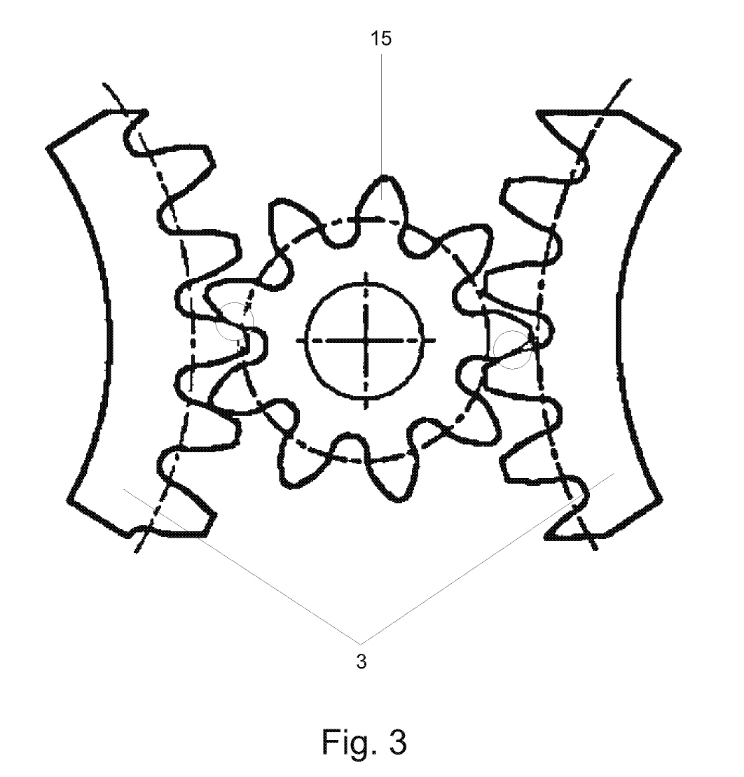

FIGS. 1 and 2 show a transmission element 1 that is to be mounted in a transmission as illustrated in an exemplary fashion in FIG. 3. This transmission is a spur gear unit with two transmission paths. Two spur gears 3 of this transmission are illustrated between which a pinion 15 of a drive shaft of a motor is arranged. The motor is connected to the transmission so that the transmission is driven by it. The pinion 15 meshes with the spur gears 3.

This transmission has zero backlash or is at least substantially free of backlash and is advantageously used in precision mechanics. The transmission element 1 has a pinion 4 on which concentrically the spur gear 3 is mounted. The pinion 4 and the spur gear 3 are arranged relative to one another so as to be free of play in the radial direction. The transmission element 1 is mounted at the drive side of the transmission in one of the transmission paths and ensures zero backlash, at least however a transmission substantially free of backlash. The transmission element 1 forms within the spur gear unit an intermediate gear 5.

On one end of the pinion 4, a disk 6 is fixedly mounted and arranged coaxially to the pinion 4. The disk 6 can be fixedly attached to the pinion 4 by force-locking, by fusing or by positive locking. The disk 6 has a circumferentially extending rim 7 that is pointing toward the spur gear 3 so that a receptacle 8 is radially outwardly delimited by it. In this receptacle a torsion spring element 2 is mounted with which torque is transmitted from the disk 6 onto the pinion 4 and onto the spur gear 3. The torsion spring element 2 is embodied as a partial ring (FIG. 2A) that extends across more than 270 degrees and whose two ends 9, 10 are angled at a right angle in opposite directions relative to one another (FIG. 2B). With these ends 9, 10 the torsion spring element 2 engages axial recesses or bores of the spur gear 3 and of the disk 6. In FIG. 1, the axial bore 11 of the spur gear 3 is shown; the end 9 of the torsion spring element 2 engages positively the bore. The disk 6 is provided with a corresponding bore that is engaged by the other end 10. In the mounted state, the bottom of the disk 6 faces the drive motor.

The torsion spring element 2 is positioned in the receptacle 8 of the disk 6 and has minimal spacing from the radial bottom 12 of the receptacle 8. The spur gear 3 is provided at the end face facing the disk 6 with a central recess 13 having the same diameter as the receptacle 8 of the disk 6. The disk 6 is positioned with the angled circumferential rim 7 against the end face of the rim 14 of the spur gear 3 that radially delimits the recess 13. In this way, the torsion spring element 2 is protected between the disk 6 and the spur gear 3.

The inner diameter of the torsion spring element 2 is slightly greater than the outer diameter of the pinion 4 in the area of the torsion spring element 2. In this way it is ensured that the torsion spring element 2 can contract slightly elastically without touching the exterior of the pinion 4.

In the mounted position, the torsion spring element 2 is elastically pretensioned in the circumferential direction so that the spur gear 3 and, by means of the disk 6, the pinion 4 are tensioned relative to one another. Between the spur gear 3 and the pinion 4 there is therefore zero backlash. As a result of the torsion spring element 2, the spur gear 3 and the pinion 4 can rotate to a limited extent elastically relative to one another.

The torsion spring element 2 has advantageously a round cross-section. It can be comprised of steel, of a non-iron material, or of plastic material. The torsion spring element 2 takes up axially and radially only minimal space so that the transmission element 1 and thus the intermediate gear 5 are of a very compact configuration. The zero backlash transmission element 1 is configured as a precision mechanics component in that the tensioning element is directly integrated in the form of the torsion spring element 2. Once the transmission element 1 is mounted in the spur gear unit, an optimal performance is provided with only a minimal number of components for realizing the zero backlash spur gear unit. By means of the zero backlash transmission element 1 two parallel transmission paths can be realized within one housing wherein these paths are tensioned relative to one another.

The torsion spring element 2 must not be a separate component but can also be generated by means of an intentionally rotary-elastic configuration of the intermediate gear 5. For example, it is possible to configure the spur gear 3 itself to have torsion spring properties.

The intermediate gear 5 has a greater elasticity than a conventional intermediate gear. The elasticity of the entire transmission path in which the intermediate gear 5 is mounted is thus of greater elasticity in comparison to conventional transmission paths. The intermediate gear 5 is advantageously mounted at a location where a relatively minimal torque is acting. In general, this will be the motor-side input of the zero backlash gear. The torque that is transmitted at this location is advantageously less than the torque with which the transmission element 1 is tensioned by the torsion spring element 2.

The specification incorporates by reference the entire disclosure of German priority document 10 2005 036 127.7 having a filing date of Jul. 26, 2005.

While specific embodiments of the invention have been shown and described in detail to illustrate the inventive principles, it will be understood that the invention may be embodied otherwise without departing from such principles.

What is claimed is:

1. A transmission element for a zero backlash transmission comprising at least two transmission paths that are tensioned relative to one another, wherein an elasticity of one of the two transmission paths is increased.

2. The transmission element according to claim 1, comprising a first transmission part and a second transmission part that are elastically tensionable relative to one another.

3. The transmission element according to claim 2, comprising at least one torsion spring element for increasing the elasticity.

4. The transmission element according to claim 3, wherein the torsion spring element transmits torque between the first and second transmission parts and the first and second transmission parts are rotatable relative to one another.

5. The transmission element according to claim 2, wherein the first transmission part is a gear wheel that is supported on the second transmission part.

6. The transmission element according to claim 2, wherein the second transmission part is a pinion.

7. The transmission element according to claim 2, wherein the first transmission part is a gear wheel and the second transmission part is a pinion and wherein the gear wheel and the pinion are coaxially positioned relative to one another.

8. The transmission element according to claim 7, wherein the gear wheel and the pinion are arranged radially without play relative to one another.

9. The transmission element according to claim 3, further comprising a disk, wherein the torsion spring element connects the disk and the first transmission part to one another.

10. The transmission element according to claim 9, wherein the disk is rotationally fixedly connected to the second transmission part.

11. The transmission element according to claim 9, wherein the disk is coaxial to the second transmission part.

12. The transmission element according to claim 9, wherein the disk is force-locked, fused, or positively connected to the second transmission part.

13. The transmission element according to claim 9, wherein the torsion spring element is positioned between the disk and the first transmission part.

14. The transmission element according to claim 9, wherein the disk has an end face provided with a first recess, wherein the torsion spring element engages the recess.

15. The transmission element according to claim 14, wherein the first transmission part has an end face with a second recess, wherein the torsion spring element engages the recess.

16. The transmission element according to claim 15, wherein the first and second recesses form a closed chamber for the torsion spring element.

17. The transmission element according to claim 3, wherein the torsion spring element is a partial ring with ends angled in opposite directions.

18. The transmission element according to clean 17, further comprising a disk, wherein the torsion spring element connects the disk and the first transmission part to one another, wherein the ends of the torsion spring element engage openings of the first transmission part and of the disk.

19. The transmission element according to claim 3, wherein an inner diameter of the torsion spring element is greater than an outer diameter of a portion of the second transmission part where the torsion spring element is arranged.

20. The transmission element according to claim 3, wherein the torsion spring element is made from steel.

21. The transmission element according to claim 3, wherein the torsion spring element is comprised of non-iron material.

22. The transmission element according to claim 3, wherein the torsion spring element is comprised of plastic material.

23. The transmission element according to claim 3, comprising a common housing in which the transmission element and the torsion spring element are arranged.

24. The transmission element according to claim 2, wherein the first transmission part is configured as a torsion spring element.

25. The transmission element according to claim 2, wherein the transmission element is an intermediate gear of the transmission.
